(19) United States
(12) Patent Application Publication
(10) Pub. No.: US 2016/0090517 A1
(43) Pub. Date: Mar. 31, 2016

(54) Absorbent Mat

(71) Applicant: Richard Allen Wroblewski, Galien, MI (US)

(72) Inventor: Richard Allen Wroblewski, Galien, MI (US)

(21) Appl. No.: 14/864,774

(22) Filed: Sep. 24, 2015

Related U.S. Application Data
(60) Provisional application No. 62/055,432, filed on Sep. 25, 2014.

(51) Int. Cl. C09K 3/32; B32B 29/00; D21H 21/22; B32B 3/12

(52) U.S. Cl. CPC C09K 3/32; B32B 3/12; B32B 29/00; D21H 21/22; B32B 2250/03; B32B 2307/726; B32B 2307/7265; B32B 2554/00

(57) ABSTRACT

The absorbent mat provides a convenient inexpensive absorbent apparatus for collecting and handling spilled oils and other hazardous liquids and includes an expanded paper honeycomb core filled with adsorbent granules sandwiched between a permeable top covering and non-permeable bottom covering.

This application claims the benefit of U.S. Provisional Patent Application, Ser. No. 62/055,432 filed Sep. 25, 2014.

This invention relates to an apparatus for cleaning and absorbing spilled oil and other liquids, and in particular an oil absorbing mat.

### BACKGROUND AND SUMMARY OF THE INVENTION

Oil spills of any size due to human activity are a frequent environmental hazard. The United State Environmental Protection Agency estimates that 10 to 25 million gallons of oil are spilled annually in the United States alone. Spilled oil ruins drinking water, is a fire and explosion hazard, damages farmland and beaches and destroys wildlife and habitats. The environmental harm can last decades.

A variety of products have been developed to absorb and collect oil spills and other hazardous liquids. Clay based absorbent granulars, such as diatomacesous earth (diatomite) and montmorillonite, have been used for collected spilled oils for many years. Other natural or organic materials have been developed for use as absorbents, such as reba bark from the bark of Norwegian pine trees. Synthetic materials, such as polypropylene, have been fashioned into absorbent pads, rolls, socks, pillows, booms and emergency spill kits, to absorb petroleum based liquids including oils, solvents, solvent based paints, vegetable oils and many other non-soluble chemicals. While spilled oil can be collected in absorbent granules, mats, rolls and floats, the handling and waste stream disposal of such hazardous items remains problematic. Manually handling and transporting oil saturation of absorbent granular, mats and rollers creates additional opportunities for hazardous contaminations, leaks, spills and exposures.

The absorbent mat of this invention provides a convenient inexpensive absorbent apparatus for collecting and handling spilled oils and other hazardous liquids. The absorbent mat of this invention includes an expanded paper honeycomb core filled with adsorbent granules sandwiched between a permeable top covering and a non-permeable bottom covering. Leaked oil passes through the permeable top cover sheet and is collected in absorbent granules encapsulated within cells of the paper honeycomb core. The non permeable bottom covering prevents the oil from leaking through the bottom of the mat when the oil saturated mat is moved. Once saturated, the mat can be conveniently and properly discarded or processed for reclaiming the collected oil. The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective view of an exemplary embodiment of the absorbent mat of this invention;

FIG. 2 is a partial perspective view of the mat of FIG. 1 shown with the outer fabric covering peeled back;

FIG. 3 is a cross sectional view of the mat of FIG. 1; and

FIG. 4 is another cross sectional view of the mat of FIG. 1.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

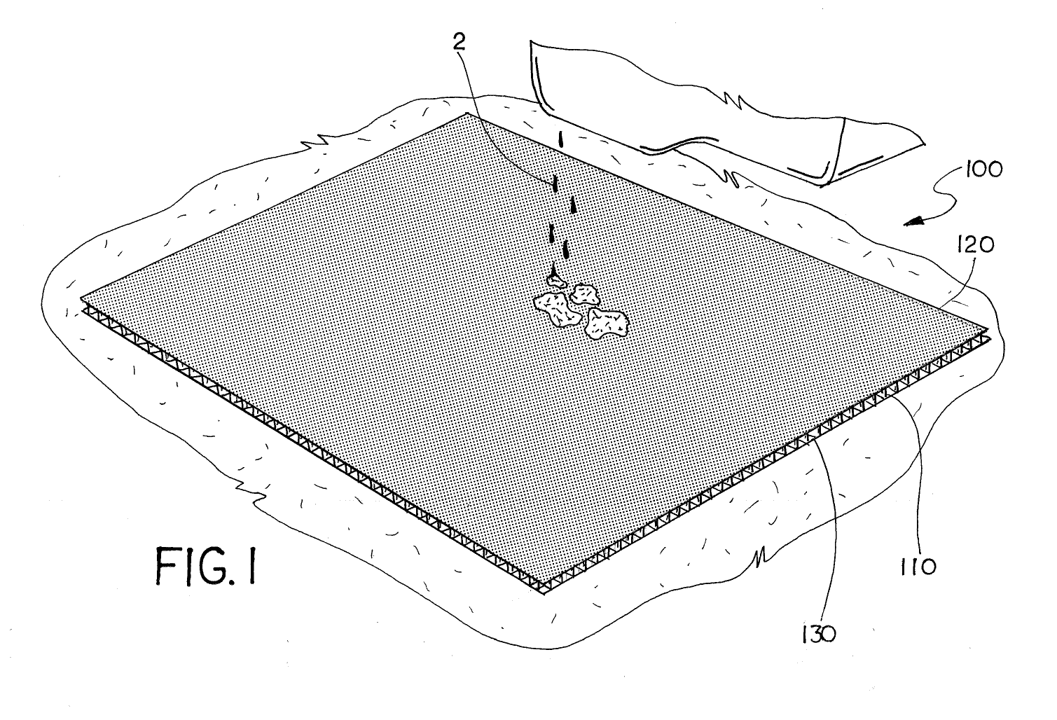

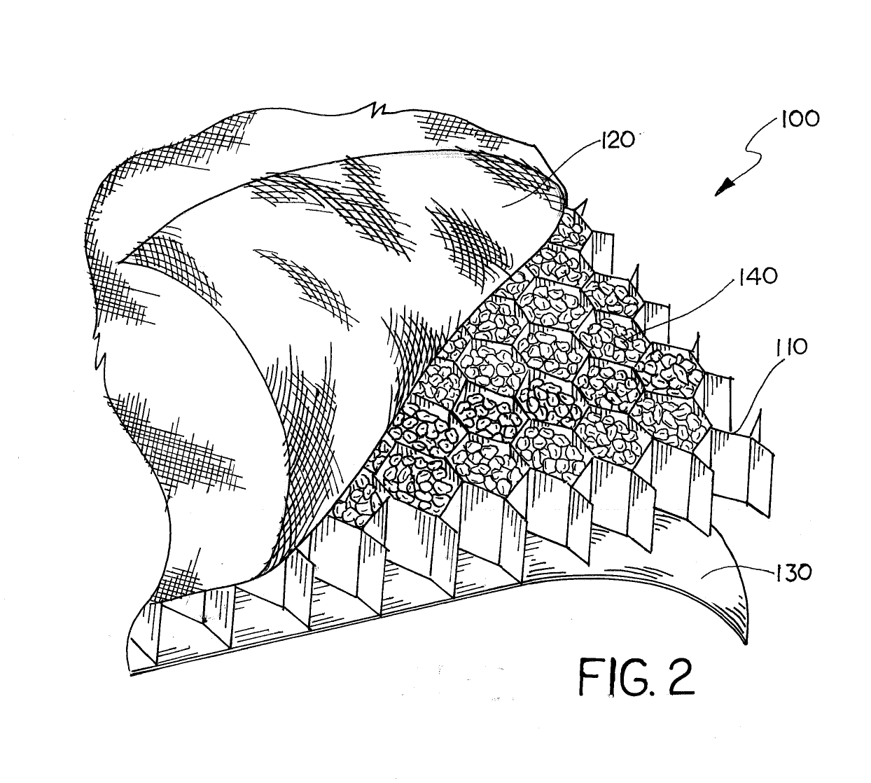

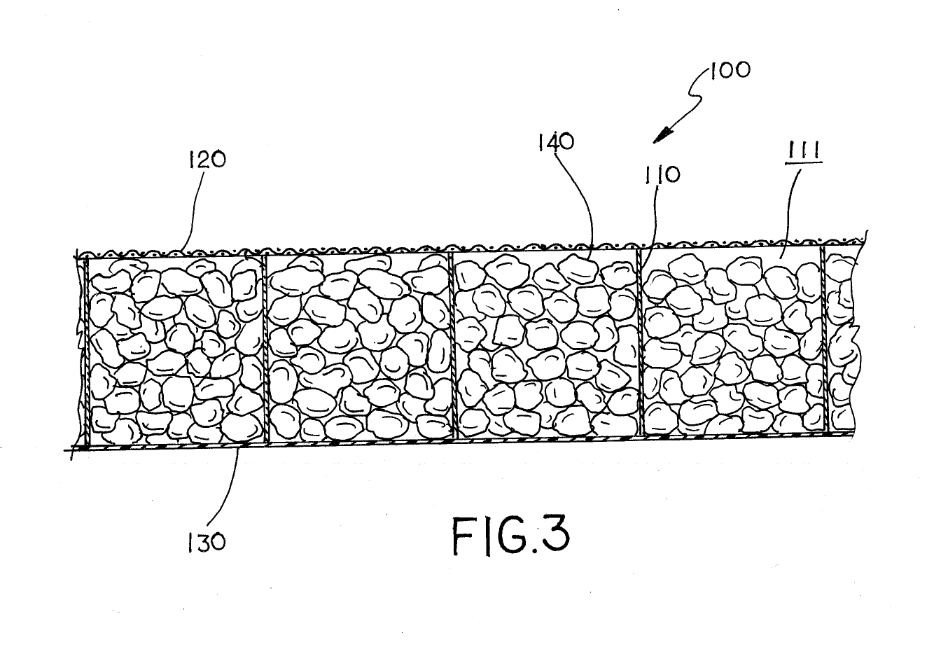

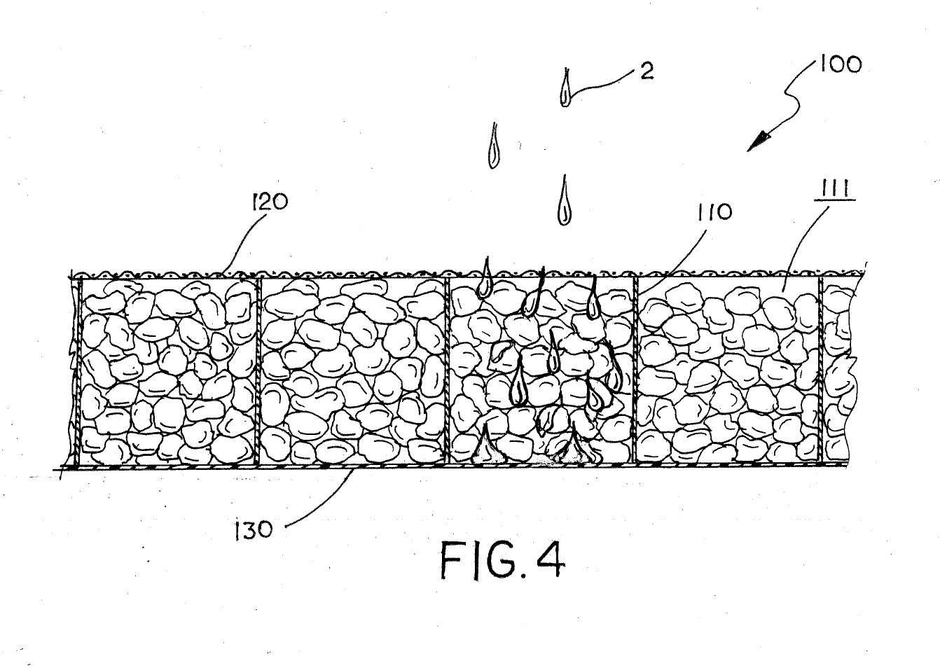

Referring now to the drawings, FIGS. 1-4 illustrate an exemplary embodiment of the absorbent mat of this invention, which is designated generally as reference numeral 100. Mat 100 is illustrated in the drawings as a floor mat such as those used in automotive repair shops to absorb spilled oil. As shown, absorbent mat 100 includes an expanded paper honeycomb core 110 filled with adsorbent granules 140 sandwiched between a permeable top covering 120 and non-permeable bottom covering 130. Paper honeycomb core is a well known building material used to make strong lightweight panels and pallets. Pare honeycomb core is produced by bonding multiple sheets of paper stock together into a continuous sheet of core stock, which is sheared or cut into strips and pressed against the previous cut strip and bonded together to form the collapsed honeycomb core. As shown in FIG. 2, honeycomb core 110 is expanded to create a plurality of open cells 111. The open cells 111 of expanded honeycomb core 110 are filled with absorbent granules 140. Any suitable absorbent granules may be used to fill cells 11 including but not limited to clay based absorbents, such as diatomacesous earth (diatomite) and montmorillonite, natural and organic absorbents, such as reba bark, or synthetic absorbents, such as polypropylene. Bottom and top coverings 120 and 130 are bonded to the expanded honeycomb core 110 by a suitable adhesive. The materials for coverings 120 and 130 are selected to suit the particular application for which the mat will be used. In the current embodiment, top covering 120 is a sheet of permeable material that allows spilled oil and other collected liquids to pass into honeycomb core 110. Bottom covering 130 is a sheet of non-permeable material that prevents spilled oil or other collected liquids from passing there through. In certain other embodiments, the materials for both covering 120 and 130 may be permeable to allow oils and other hazardous liquids to pass into the expanded honeycomb core. The materials for covering 120 and 130 are selected based on the particular use and application of absorbent mat 100.

In use as a floor mat, absorbent mat 100 is placed on the floor where oil spills are excepted. Leaked oil 2 passes through the permeable top covering 120 and is collected in absorbent granules 140 encapsulated within cells of the paper honeycomb core 110. The non permeable bottom covering 140 prevents the oil from leaking through the bottom of mat 100 when the oil saturated mat 100 is moved. Once saturated, mat 100 can be conveniently and properly discarded or processed for reclaiming the collected oil. The paper honeycomb core provides an inexpensive, light-weight, durable and pliable support structure for physically encapsulating the absorbent granules.

In certain other embodiments, the absorbent mat with the absorbent granule filled honeycomb core may be adapted for collecting spilled oils and contaminants from surface water. In such embodiments, the absorbent mat may be affixed or supported on buoyancy floats so that the mat floats on the top of the surface water. The covering sheets and honeycomb core itself of such embodiments may be manufactured from oil permeable but hydrophobic materials, which allows the oils to be adsorbed within the mat but repels water.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1: An absorbent mat comprising:
an expanded honeycomb core having a bottom, a top and a plurality of open cells;
a first covering bonded to the honeycomb core bottom;
a second covering bonded to the honeycomb core top; and
absorbent granules disposed within the plurality of open cells of the honeycomb core.

2: The absorbent mat of claim 1 wherein the first covering is constructed of a sheet of non-permeable material.

3: The absorbent mat of claim 1 wherein the second covering is constructed of a sheet of oil permeable material.

4: The absorbent mat of claim 1 wherein the honeycomb core is constructed of paper.
